(19) United States
(12) Patent Application Publication
(10) Pub. No.: US 2006/0243832 A1
(43) Pub. Date: Nov. 2, 2006

(54) Recovery process for high aspect ratio materials

(75) Inventor: Neil A. McMinn, Turner Valley (CA)

Correspondence Address: RODMAN RODMAN, 7 SOUTH BROADWAY, WHITE PLAINS, NY, 10601, US

(73) Assignee: Fording Inc., Calgary (CA)

(21) Appl. No.: 10/566,900

(22) PCT Filed: Aug. 8, 2003
(86) PCT No.: PCT/CA03/01211

§ 371 Date: Jul. 5, 2006

(51) Int. Cl. B02C 17/00

(52) U.S. Cl. 241/24.1

(57) ABSTRACT

Apparatus and process for separating particles of wollastonite ore and other aspect ratio materials into a relatively high aspect ratio constituent and a relatively low aspect ratio constituent includes an initial step of either size reducing (2) the material into particles of the aspect ratio material having a size less than a preselected maximum size or alternatively providing such particles of the aspect ratio material. The particles of the aspect ratio material are then separated (4) into a plurality of particle streams based on particle size such that each particle stream is formed substantially from particles within a particular range of particle sizes. Then, the particles in at least one particle stream are sorted (6) based on particle shape into the relatively high and relatively low aspect ratio constituents. The particle separation step (4) is preferably performed using mesh screening apparatus. The shape sorting step (6) is preferably performed using apparatus for separating grain.

### FIELD OF THE INVENTION

This invention relates to a method for sorting materials, and in particular relates to a process for sorting aspect ratio materials, including minerals such as wollastonite ore, into a relatively high aspect ratio constituent and a relatively low aspect ratio constituent. The invention also relates to the products obtained from the process.

### BACKGROUND OF THE INVENTION

There are both naturally occurring and man-made materials which include particles which have a length or width which is greater than their diameter or thickness. Such particles are described as having an aspect ratio which is greater than one, where aspect ratio represents the ratio between the largest dimension of a particle and a smaller dimension of the particle.

Materials which include particles having an aspect ratio greater than one may be described generally as “aspect ratio materials”. Aspect ratio materials may be “acicular” (i.e., “needle-shaped” or “fibrous”) or may be “platey” (i.e., “flake-like” or “platelet-shaped”). Aspect ratio materials may include particles which have a relatively high aspect ratio and particles which have a relatively low aspect ratio. Aspect ratio materials may also contain impurities, which impurities are often present in the form of particles which have a relatively low aspect ratio. As used herein, the term “aspect ratio material” refers to a material which includes particles which have an aspect ratio greater than one.

Examples of aspect ratio materials include, but are not limited to, inorganic fibres (such as, for example glass fibre, carbon fibre, wollastonite, fibrous talc, chrysotile asbestos, crocidolite asbestos and amosite asbestos), organic fibres (such as, for example cellulose, polypropylene fibre, polyvinyl acetate fibre, acrylic fibre, polyester fibre, polyamide (nylon) fibre, polyethylene fibre and aramid fibre), man-made mineral fibres (such as, for example rock wool, stone wool, slag wool, basalt fibre and ceramic fibre) and platelets (such as, for example mica, platey talc, vermiculite, amosite asbestos, graphite flake and metal flake (such as, for example aluminum flake and silver flake).

Aspect ratio materials may exist in many different particle sizes within a particular sample, and may be combined or mixed with materials, including impurities, which do not exhibit an aspect ratio greater than one. It would for many scientific, engineering, construction and manufacturing applications be advantageous to be able to sort aspect ratio materials into a relatively high aspect ratio constituent and a relatively low aspect ratio constituent. It would also be advantageous to be able to separate aspect ratio materials into high aspect ratio constituents of varying sizes.

Conventionally, materials may be separated into particles of different sizes through the use of sieving. In the case of non-aspect ratio materials, particle size may be defined with reference to the size of the mesh opening through which a particular particle may pass. In the case of aspect ratio materials, however, the size of the mesh opening defines only a smaller dimension of a particular particle, since a fibre or platelet may pass lengthwise through the mesh opening. As a result, the particle size of aspect ratio materials must be defined by both mesh size and aspect ratio.

Wollastonite (CaSiO₃) is a naturally occurring white, non-metallic mineral with a naturally occurring acicular or needle-shaped crystal structure. Consequently, wollastonite cleaves into needle-like particles which exhibit great strength. Wollastonite is considered non-toxic and non-carcinogenic, and health and safety concerns during handling are limited to those associated with nuisance dusts, which are qualities that have made it a preferred mineral reinforcing material. The distinctive physical and chemical properties and benign health characteristics of wollastonite make it an ideal performance mineral for a broad range of industrial and consumer applications including plastic composites, sealants, caulks and mastics, friction materials, paints and corrosion-resistant coatings, fire-resistant products and cement-based applications, ceramics, wall and floor tiles, and sanitary ware.

Because of its unique cleavage properties, wollastonite naturally forms into needle-shaped particles of varying aspect ratio, with the result that wollastonite is a naturally occurring aspect ratio material. This distinctive property can impart improved strength, stiffness, impact resistance and dimensional stability to a wide range of materials and is of considerable importance in wollastonite's diverse market applications. The brightness and whiteness of wollastonite also enhances its use in certain filler and ceramic applications.

Conventional processing of wollastonite initially involves mining of wollastonite ore from a mine site using conventional surface mining methods. Mining is typically followed by several stages of crushing, grinding or other size reducing techniques for initial size reduction. The wollastonite is then separated from its associated impurities (referred to as ‘beneficiated’) typically by one of the following methods:
1. successive stages of fine crushing followed by dry magnetic separation to remove minerals such as garnet and diopside. These minerals are to varying degrees magnetic and generally several steps of magnetic separation is required. Thermal drying of the ore is carried out to ensure effective magnetic separation.
2. alternatively, initial crushing and grinding is followed by wet processing (flotation) to remove minerals such as calcite, diopside, and feldspars. Filtration and thermal drying of the resulting wollastonite concentrate is required after wet processing.

High aspect ratio (HAR) wollastonite is considered generally to be a more desirable product than low aspect ratio (LAR) wollastonite in certain applications. Aspect ratio refers to the relative proportions of length and diameter of wollastonite particles. For example, a wollastonite particle having an aspect ratio of 5:1 has a length which is five times greater than the diameter of the particle.

The size reduction of wollastonite (and other aspect ratio materials) may tend to diminish the aspect ratio of the resulting particles of the material and may even result in the material ceasing to be an aspect ratio material. For example, it is possible to crush and/or grind wollastonite into grains or powders which have a very low aspect ratio. As a result, the processing of wollastonite should for most applications be carried out with care to minimize the extent to which size reducing techniques such as crushing and/or grinding diminish the aspect ratio of the resulting particles.

Efficient and automated methods of separating wollastonite into relatively high aspect ratio and relatively low aspect ratio constituents are lacking in the industry. Conventionally, separation of wollastonite into high aspect ratio grades and low aspect ratio grades has been performed by hand at the mine site using a large labour force at considerable cost.

There is therefore a need for an efficient process for separating wollastonite and other aspect ratio materials into a relatively high aspect ratio constituent and a relatively low aspect ratio constituent. There is also a need for such a process which is capable of controlling the particle size of the relatively high aspect ratio constituent in order to facilitate production of relatively high aspect ratio products having a particular particle size. Finally, there is a need for the products which may be produced by such a process.

### SUMMARY OF THE INVENTION

The present invention is directed at a process for separating an aspect ratio material into a relatively high aspect ratio constituent and a relatively low aspect ratio constituent. The process of the present invention may also be utilized to produce relatively high aspect ratio products of specific and/or varying particle sizes. The present invention is also directed at the products produced by the process.

The aspect ratio material which is separated using the process of the present invention may be comprised of any natural or man-made aspect ratio material which is suitable for processing according to the process steps described herein.

Examples of suitable aspect ratio materials include, but are not limited to, inorganic fibres (such as, for example glass fibre, carbon fibre, wollastonite, fibrous talc, chrysotile asbestos, crocidolite asbestos and amosite asbestos), organic fibres (such as, for example cellulose, polypropylene fibre, polyvinyl acetate fibre, acrylic fibre, polyester fibre, polyamide (nylon) fibre, polyethylene fibre and aramid fibre), man-made mineral fibres (such as, for example rock wool, stone wool, slag wool, basalt fibre and ceramic fibre) and platelets (such as, for example mica, platey talc, vermiculite, amosite asbestos, graphite flake and metal flake (such as, for example aluminum flake and silver flake).

One example of a type of aspect ratio material which may not be suitable for use in the present invention is a material which, although including particles possessing a relatively large aspect ratio, does not exhibit sufficient particle rigidity such that the aspect ratio of the particles can be effectively exploited by shape sorting techniques.

In one aspect, the invention is a process for shape sorting an aspect ratio material, the process comprising:

providing particles of the aspect ratio material having a size less than a preselected maximum size;

separating the particles of the aspect ratio material into a plurality of particle streams based on particle size, each particle stream being formed substantially from particles of the aspect ratio material having a size within a range of particle sizes; and

sorting the particles of the aspect ratio material in at least one of the plurality of particle streams based on particle shape into a relatively high aspect ratio constituent and a relatively low aspect ratio constituent.

The particles of the aspect ratio material may either be provided for separation and sorting directly without size reducing if the particles have the size less than the predetermined size, or they may be subjected to size reducing to the size less than the predetermined size and then provided for separation and sorting. In either case, the sorting step requires that the material to be sorted is an aspect ratio material.

In a preferred embodiment the process relates to the separation of particles of a wollastonite ore as an aspect ratio material into a relatively high aspect ratio constituent and a relatively low aspect ratio constituent and it has been found that the process and system of the present invention can successfully separate particles of a wollastonite ore into one or more relatively high aspect ratio constituents and one or more relatively low aspect ratio constituents.

As used herein, the term “wollastonite ore” refers to any material which contains wollastonite, which material may contain impurities or other substances in addition to wollastonite.

Accordingly, in a preferred embodiment the present invention provides a process for shape sorting particles of a wollastonite ore as the aspect ratio material comprising:

providing particles of the wollastonite ore as the aspect ratio material having a size less than a preselected maximum size;

separating the particles of the wollastonite ore into a plurality of particle streams based on particle size, each particle stream being formed substantially from particles of the wollastonite ore having a size within a range of particle sizes;

sorting the particles of the wollastonite ore in at least one of the plurality of particle streams based on particle shape into a relatively high aspect ratio constituent and a relatively low aspect ratio constituent.

The process may also comprise the step, prior to the separating step, of size reducing the wollastonite ore into the particles having the size less than the preselected maximum size. The size reducing step is preferably carried out in a manner so as to preserve, to the extent possible, the aspect ratio of the wollastonite particles, since the sorting step requires that the material to be sorted is an aspect ratio material.

In a further aspect, a preferred embodiment of the present invention provides a system for shape sorting particles of a wollastonite ore as the aspect ratio material comprising:

particle size separating apparatus to separate particles of the wollastonite ore having a size less than a preselected maximum size into a plurality of particle streams based on particle size, each particle stream being formed substantially from particles of the wollastonite ore having a size within a range of particle sizes; and

particle shape sorting apparatus associated with at least one of the particle streams to sort the particles of the wollastonite ore in the particle stream based on particle shape into a relatively high aspect ratio constituent and a relatively low aspect ratio constituent.

The system may also comprise a size reducing apparatus to reduce the wollastonite ore into the particles having the size less than the preselected maximum size. The size reducing apparatus is preferably selected to minimize the extent to which size reduction of the wollastonite ore will diminish the aspect ratio of the resulting particles of wollastonite ore, since the sorting step requires that the material to be sorted is an aspect ratio material.

Finally, in a further aspect, a preferred embodiment of the present invention provides wollastonite products having specific properties resulting from the process of the present invention.

### BRIEF DESCRIPTION OF THE DRAWINGS

Aspects of the present invention are illustrated, merely by way of example, in the accompanying drawings in which:

FIG. 1 is a flow chart of a preferred process according to the present invention; and

FIG. 2 is a detail view showing features of a preferred embodiment of a particle shape sorting apparatus for use in the invention.

### DESCRIPTION OF THE PREFERRED EMBODIMENTS

The process of the present invention may be used to separate particles of a suitable aspect ratio material into a relatively high aspect ratio constituent and a relatively low aspect ratio constituent. In the preferred embodiment, the aspect ratio material is wollastonite.

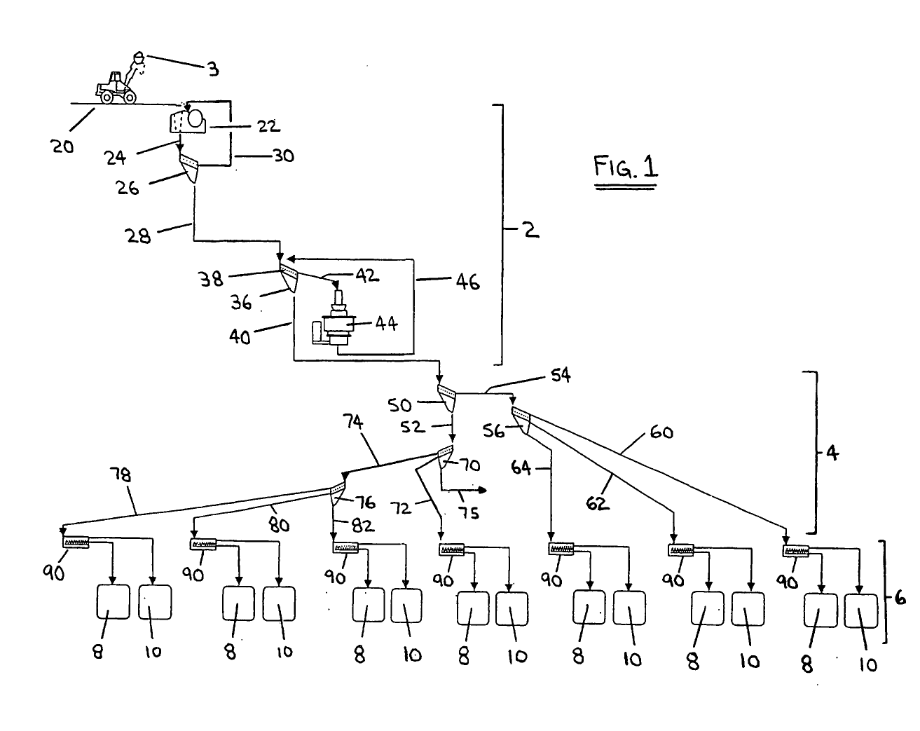

FIG. 1 shows schematically a preferred process according to the present invention for shape sorting particles of a wollastonite ore into one or more relatively high aspect ratio constituents and one or more relatively low aspect ratio constituents. The process may be used to produce from the wollastonite ore one or a number of different relatively homogeneous products which exhibit a relatively high aspect ratio particle shape and a particular particle size range.

The overall process can be divided into the following basic steps:
1. a size reducing step 2 in which a wollastonite ore 3 is reduced to particles having a size less than a preselected maximum size (the size reducing step 2 may not be required as part of the invention where the wollastonite ore 3 is available to be provided in a state such that the particles already have a size less than the preselected maximum size. In either case, the wollastonite ore 3 must be provided to the steps that follow as an aspect ratio material.
2. a separating step 4 in which the particles of wollastonite ore 3 are divided into a plurality of particle streams based on particle size such that each particle stream is formed substantially from particles within a range of particle sizes.
3. a sorting step 6 in which the particles of wollastonite ore 3 in at least one of the plurality of particle streams is sorted based on particle shape into a relatively high aspect ratio constituent 8 and a relatively low aspect ratio constituent 10.

In the following description, particle sizes are defined in units of millimetres and represent the approximate size in millimetres of a square or rectangular mesh opening through which a particle will pass.

In the illustrated process of FIG. 1, size reducing step 2 involves breaking down of wollastonite ore 3 into particles having a size less than a preselected maximum size. Size reducing step 2 is not required as part of the invention where the wollastonite ore 3 is already present as particles of wollastonite which have the size less than the preselected maximum size, such as may be the case if pre-sized wollastonite ore 3 is provided to the process or if the wollastonite ore 3 as mined already consists of particles having a size less than the preselected maximum size. Regardless of how the particles of wollastonite ore 3 having the size less than the preselected size are created, the particles must be provided to the following steps of the process as an aspect ratio material.

Since wollastonite is an acicular material, the “size” of a wollastonite particle having a length greater than both its width or thickness will be defined by the smallest size of mesh opening through which the wollastonite particle will pass, which size of mesh opening will typically be represented by the larger of the width or thickness of the wollastonite particle and not by the length of the wollastonite particle.

As a result, reference to size of a wollastonite particle in this specification relates to the size of mesh opening through which the wollastonite particle will pass, regardless of the aspect ratio of the wollastonite particle.

It has been found in pilot plant trials with selected deposits of wollastonite that the maximum particle size of wollastonite ore 3 particles that can effectively be subjected to shape separation for the particular mineral deposit used in testing is about 3.5 mm.

At sizes greater than about 3.5 mm, particles from test wollastonite deposits have been found not to readily exhibit an acicular shape because a given particle of wollastonite having a particle size of greater than about 3.5 mm may constitute an aggregation of acicular wollastonite particles and other material such as gangue (waste material and impurities) and because the wollastonite particles themselves may not exhibit a high degree of acicularity as their size increases.

The maximum particle size at which liberation and separation of constituents becomes difficult is dependent on the aspect ratio material and the characteristics of a particular deposit or sample of the aspect ratio material. As a result, the maximum particle size which may be subjected to shape sorting in the described embodiment of the present invention will depend on the particular wollastonite deposit that is being processed.

In order to reduce the wollastonite ore 3 to particles having the preselected maximum particle size the wollastonite ore 3 is passed through a size reducing apparatus which may comprise one or more pieces of crushing apparatus. The size reducing step 2 may be performed in a single stage or alternatively in two or more stages using a similar or different size reducing apparatus at each stage, with particles being crushed to an intermediate size at one stage for delivery to the size reducing apparatus at the subsequent stage until the particles are reduced to the size less than the preselected maximum size.

The procedure illustrated in FIG. 1 is an example of a size reducing process that relies on several crushing stages to break down the particles to a desired maximum particle size. Initially, wollastonite ore 3 mined using conventional techniques is transported by a loader 20 to a size reducing apparatus, which comprises a first crushing apparatus 22.

Preferably, first crushing apparatus 22 is a jaw type crusher selected to crush the ore into particle sizes of less than about 75 mm. The output stream 24 is then screened at screening apparatus 26 which separates wollastonite ore 3 particles that are less than about 60 mm (particle stream 28) from larger particles (particle stream 30). The larger particles of particle stream 30 are then preferably recycled back to the first crushing apparatus 22, until the wollastonite ore 3 is crushed to particle sizes of less than about 60 mm.

Alternatively, a further crushing apparatus (not shown) similar to or different from the first crushing apparatus 22 may be provided for further size reduction of the wollastonite ore 3, but care should be exercised in the selection of both the first crushing apparatus 22 and any further crushing apparatus to avoid selecting a crushing apparatus which will significantly diminish the aspect ratio of the wollastonite ore 3, since the sorting step 6 requires that the material to be sorted is an aspect ratio material.

For example, it has been found that cone type crushers may significantly impair the aspect ratio of the resulting particles of wollastonite ore 3 and should therefore preferably be avoided as either the first crushing apparatus 22 or as a further crushing apparatus.

Particle stream 28 is further screened for size using screening apparatus 36 which includes a 3.5 mm (approximate) screen 38. Screen 38 acts to separate wollastonite ore 3 particles that have a size less than 3.5 mm (approximate) (particle stream 40) from larger particles (particle stream 42).

The larger particles of stream 42 are then preferably further size reduced in a second crushing apparatus 44. Second crushing apparatus 44 is preferably a high aspect ratio (HAR) type crusher which is capable of crushing the wollastonite ore 3 particles while generally preserving their aspect ratio. An exemplary high aspect ratio (HAR) crusher is a Barmac crusher or a VSI crusher, both of which are manufactured by Metso Minerals Oy, an affiliate of Metso Corporation.

It will be understood that it may be necessary to recycle size reduced particles through one or more of the particular size reducing apparatus until the desired output particle size is reached.

After size reducing step 2, particle stream 40 is comprised substantially of particles having a particle size less than the preselected maximum size. In the illustrated embodiment of the invention, the preselected maximum size for the wollastonite ore 3 particles is about 3.5 mm.

Particle stream 40 is then fed to a particle size separating apparatus for performing separating step 4. This separating step 4 involves separating the particles into two or more particle streams based on particle size such that each particle stream is formed substantially from particles within a range of particle sizes. Any equipment or apparatus which is capable of performing the separating step 4 may be used in the invention as the particle size separating apparatus.

Preferably, the particle size separating apparatus comprises at least one mesh screen apparatus each containing one or more mesh screens with openings of an established size. In the illustrated embodiment, particle stream 40 is separated into a plurality of different streams of wollastonite ore 3 particles by a plurality of mesh screen apparatus.

In the illustrated process, eight different particle streams are created with a range of particle sizes from about 3.5 mm to about −0.25 mm. It will be appreciated that there can be more or fewer streams of wollastonite ore 3 particles created during the separating step 4 depending upon considerations such as the properties of the wollastonite deposit and the desired characteristics of the final products of the process. It will also be appreciated that the particle size distribution for the various particle streams may vary from application to application depending upon similar considerations.

Each mesh screen creates one particle stream in which the particles are greater in size than the mesh screen size and another particle stream in which the particles are smaller in size than the mesh screen size. In the illustrated embodiment the separation of the particles by screening is repeated with mesh screens of different sizes to create a plurality of particle streams having different ranges of particle sizes. A single mesh screen apparatus may comprise one mesh screen or a plurality of mesh screens.

Referring to FIG. 1, particle stream 40 is initially fed to screening apparatus 50 having a 1.2 mm (approximate) screen which separates the wollastonite ore 3 particles that are less than 1.2 mm (approximate) in size particle stream 52) from larger particles (particle stream 54). Particle stream 54 undergoes further size separation in screening apparatus 56 having two mesh screens: a 2.4 mm (approximate) screen and a 1.7 mm (approximate) screen.

Screening apparatus 56 creates three streams of particles, namely, particle stream 60 containing particles that range between about 3.5 mm and about 2.4 mm in size, particle stream 62 containing particles that range between about 2.4 mm to about 1.7 mm in size, and particle stream 64 containing particles that range between about 1.7 mm and about 1.2 mm in size.

In a similar manner, particle stream 52 undergoes further size separation in a screening apparatus 70 having two mesh screens: a 0.30 mm (approximate) screen and a 0.25 mm (approximate) screen. Screening apparatus 70 creates three streams of particles, namely, particle stream 72 containing particles that range between about 0.30 mm and about 0.25 mm in size, particle stream 74 containing particles that are between about 1.2 mm and about 0.30 mm in size, and particle stream 75 containing particles that are smaller than about 0.25 mm in size.

Particle stream 74 is fed to screening apparatus 76 having two screens: a 0.85 mm (approximate) screen and a 0.60 mm (approximate) screen. Apparatus 76 creates three streams of particles, namely, particle stream 78 containing particles that range between about 1.2 mm and about 0.85 mm in size, particle stream 80 containing particles that range between about 0.85 mm and about 0.60 mm in size, and particle stream 82 containing particles that range between about 0.60 mm and about 0.30 mm in size.

In the illustrated embodiment, the size separating step 4 is carried out based on the width or thickness of the wollastonite ore 3 particles and is carried out using mesh screening techniques and apparatus. The size separating step 4 may, however, be carried out using any other techniques and/or apparatus which are capable of producing a plurality of particle streams based upon the size of the particles of wollastonite ore 3.

The multiple sized particles streams 60, 62, 64, 72, 78,80 and 82 created during size separating step 4 are subsequently subjected to a shape sorting step 6 in which each particle stream is independently subjected to shape sorting to produce a relatively high aspect ratio constituent 8 and a relatively low aspect ratio constituent 10. Particle stream 75 is not typically subjected to the sorting step 6 due to the small size of the particles comprising particle stream 75.

The shape sorting step 6 is preferably designed so that a threshold aspect ratio represents a separation threshold between the relatively high aspect ratio constituent 8 from the relatively low aspect ratio constituent 10. In other words, the sorting step 6 may be designed so that nominally, particles having an aspect ratio greater than the threshold aspect ratio form part of the relatively high aspect ratio constituent 8, while particles having an aspect ratio less than the threshold aspect ratio form part of the relatively low aspect ratio constituent 10.

In practice, it is difficult if not impossible to ensure that absolute accuracy is achieved in the shape sorting step 6 in sorting the particles above and below the threshold aspect ratio, due to process and apparatus limitations. As a result, the terms “relatively high aspect ratio constituent” and “relatively low aspect ratio constituent” are not intended as absolute terms, but only relative terms having regard to a particular particle stream.

The dividing line between the relatively high aspect ratio constituent and the relatively low aspect ratio constituent may in some circumstances be more positively defined with reference to a desired property of the constituent other than its aspect ratio.

For example, in the illustrated embodiment where the material is wollastonite, the dividing line may be established with reference to the amount of Loss-on-Ignition exhibited by each of the relatively high aspect ratio constituent and the relatively low aspect ratio constituent. Loss-on-Ignition is the amount of weight loss in percent which is experienced by a particular material sample when it is heated to 1000 degrees Celsius.

A relatively high Loss-on-Ignition value typically indicates that a material contains a relatively high percentage of impurities. One impurity commonly found in wollastonite is calcium carbonate, a volatile mineral material which generally exhibits a very low aspect ratio and which typically contributes to a large extent to the Loss-on-Ignition value of wollastonite.

One of the benefits of the process of the present invention is that the sorting step 6 results in the separation of impurities (such as calcium carbonate) from the relatively high aspect ratio constituent, which results in a corresponding lower Loss-on-Ignition being exhibited by the relatively high aspect ratio constituent in comparison with the relatively low aspect ratio constituent.

As a result, the dividing line between the relatively high aspect ratio constituent and the relatively low aspect ratio constituent for a particular application may in some circumstances be characterized by a desired Loss-on-Ignition value for one or both of the constituents, which in turn may constitute an indication of the purity of the constituents.

Furthermore, since impurities found in wollastonite may generally exhibit a relatively low aspect ratio, the Loss-on-Ignition value of the wollastonite constituents may also constitute an indication of the aspect ratio of the constituents.

Sorting step 6 preferably involves delivering each size separated particle stream to particle shape sorting apparatus 90 for sorting based on particle shape. Preferably the shape sorting step 6 involves the sorting of each of the particle streams 60, 62, 64, 72, 78, 80 and 82 into only two constituents in order to simplify the shape sorting step 6. In the illustrated embodiment, a plurality of particle shape sorting apparatus 90 is provided so that each particle stream is sorted by a separate particle shape sorting apparatus 90.

In an alternate embodiment (not shown), each or some of the particle streams may be sorted by a plurality of particle shape sorting apparatus 90. The plurality of particle shape sorting apparatus 90 may be configured in parallel to increase the throughput of the particle shape sorting apparatus 90 or may be configured in series to provide for additional discrimination between the relatively high aspect ratio constituent and the relatively low aspect ratio constituent.

The sorting step 6 may be carried out using any techniques and/or apparatus which are effective to produce the relatively high aspect ratio constituent 8 and the relatively low aspect ratio constituent 10.

In prototype testing, a preferred particle shape sorting apparatus 90 comprises grain sorting apparatus.

For example, a Northland Superior Supply Company Ltd. high capacity separator manufactured in Thunder Bay, Ontario, Canada has been found to function well as the sorting apparatus 90 to sort the particle streams 60, 62, 64, 72, 78, 80 and 82 into relatively high aspect ratio and relatively low aspect ratio constituents. In particular, successful testing of the invention has been carried out using either the Northland Superior Supply Company Ltd. Model NS-B1 (single cylinder) or Model NS-B2 (two cylinder) high capacity separator.

Other grain separators such as the module indented cylinder system manufactured by Westrup, Inc of Plano, Tex. or the Carter Day Modular Uni-Flow grain separator sold by Scott-Moeller Company in Moorhead, Minn. may also be suitable for use as particle shape sorting apparatus 90 in the shape sorting step 6.

The Carter Day Modular Uni-Flow grain separator is described in U.S. Pat. No. 5,335,792, which issued to Carter Day International, Inc. of Minneapolis, Minn. The Carter Day Modular Uni-Flow grain separator is an “indented cylinder” type particle shape sorting apparatus 90.

As an acicular mineral, the length:diameter or aspect ratio of wollastonite particles typically ranges from 2:1 to 10:1, with an average of 5:1. In other words, since each of the sized particle streams 60, 62, 64, 72, 78,80 and 82 produced in separating step 4 are sorted based on size, they contain particles of varying lengths and aspect ratios. The other minerals or ‘gangue’ that may be present in minor amounts in a wollastonite ore 3 deposit in addition to wollastonite typically have an aspect ratio of less than 2:1.

As a result, the gangue contained in a wollastonite ore 3 deposit will tend to be sorted with the relatively low aspect ratio constituents 10. It may therefore be desirable to clean the relatively low aspect ratio wollastonite constituents 10 to remove gangue. Such cleaning may be achieved using methods such as dry magnetic separation to remove minerals such as garnet and diopside or a wet flotation process.

Alternatively, all particle streams 60, 62, 64, 72, 78, 80 and 82 may be subjected to a cleaning step at the end of size separating step 4 and prior to the shape sorting step 6 to remove gangue prior to shape sorting. This alternative is not generally preferred, since it involves cleaning of the wollastonite ore 3 particles which ultimately comprise the relatively high aspect ratio constituent 8, which cleaning may in many circumstances be unnecessary.

As a result of the variation in aspect ratio within each sized particle stream, there exists an opportunity for shape sorting during the shape sorting step 6 based on the length of the particles. As previously indicated, grain sorting apparatus has been found to provide a suitable particle shape sorting apparatus 90 for such shape sorting.

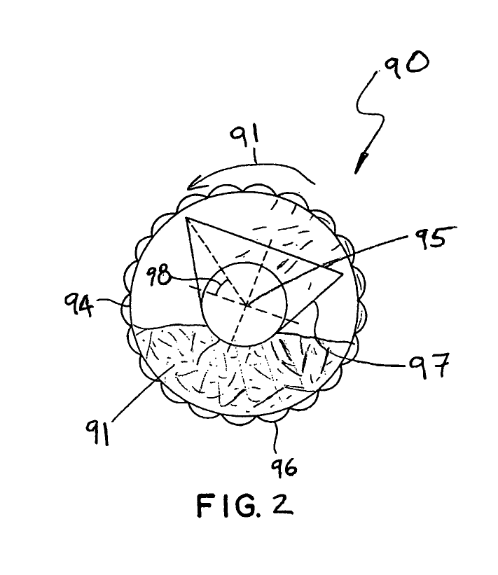

As previously indicated, a preferred grain sorting apparatus for use in the process as the particle shape sorting apparatus 90 is a Northland Superior Supply Company Ltd. Model NS-B1 or Model NS-B2 high capacity grain separator, features of which are depicted in FIG. 2.

Referring to FIG. 2, the preferred sorting apparatus 90 includes a rotatable cylinder 94 lined on its interior surface with an array of semi-spherical indents 96 which act to contain wollastonite ore 3 particles based on their length. Cylinder 94 is rotatable about centerline 95 in the direction indicated by arrow 91. FIG. 2 provides a cross section through cylinder 94 into which a particle stream of wollastonite ore 3 particles obtained from the size separating step 4 are fed.

Indents 96 are sized to receive and lift particles of a limited length or diameter from the interior of cylinder 94 as the cylinder rotates. Within cylinder 94, there is an internal trough 97. The orientation of the internal trough 97 within the rotatable cylinder 94 is adjustable by rotating the trough 97 to increase or decrease the relative angle 98 of the trough 97 to the centerline 95 of the rotatable cylinder 94. Trough 97 includes an internal helical screw (not shown) to maintain movement of the particles along the trough 97.

For a given particle size, relatively low aspect ratio particles will tend to be carried upwards in the indents 96 and then fall from the indents 96 into trough 97 while relatively high aspect ratio particles will tend not to be carried upwards in the indents 96 to the same extent and will thus tend to remain in the interior of rotatable cylinder 94. Thus, two streams of shape sorted particles are formed, with the relatively high aspect ratio constituent 8 exiting from cylinder 94 and the relatively low aspect ratio constituent 10 exiting from trough 97.

The overall shape characteristics of the particles comprising the relatively high aspect ratio constituent 8 and the relatively low aspect ratio constituent 10, and the proportionate yields of the constituents 8, 10 can be controlled in part by adjusting the relative angle 98 of the trough 97 to the centerline 95 of cylinder 94, by altering the size (i.e., diameter and/or depth) of the indents 96, by adjusting the residence time (i.e., the throughput rate) of the particles in the cylinder 94, and by adjusting the speed of rotation of the cylinder 94.

In general, as the trough 97 is adjusted by rotating it in a direction opposite to the direction of rotation 91 of the rotatable cylinder 94, thus increasing the relative angle 98, relatively more particles will be deposited in the trough 97 and the yield of the relatively high aspect ratio constituent 8 relative to the relatively low aspect ratio constituent 10 will decrease.

In general, as the diameter of the indents 96 in the rotatable cylinder 94 decreases, relatively fewer particles will be carried upwards in the indents 96 and deposited in the trough 97 and the yield of the relatively high aspect ratio constituent 8 relative to the relatively low aspect ratio constituent 10 will increase.

In general, as the depth of the indents 96 in the rotatable cylinder 94 increases, relatively higher aspect ratio particles will be carried upwards in the indents 96 and deposited in the trough 97 and the yield of the relatively high aspect ratio constituent 8 relative to the relatively low aspect ratio constituent 10 will decrease.

In general, as the residence time of the wollastonite ore 3 in the rotatable cylinder 94 increases (i.e. as the throughput rate decreases), relatively more particles will be carried upwards in the indents 96 and deposited in the trough 97 and the yield of the relatively high aspect ratio constituent 8 relative to the relatively low aspect ratio constituent 10 will decrease.

In general, as the speed of rotation of the rotatable cylinder 94 increases, relatively more particles will be carried upwards in the indents 96 by momentum and deposited in the trough 97 and the yield of the relatively high aspect ratio constituent 8 relative to the relatively low aspect ratio constituent 10 will decrease.

In general, as the yield of the relatively high aspect ratio constituent 8 increases, its average aspect ratio will decrease and its Loss-on-Ignition value will increase.

Table 1 and the discussion that follows illustrates some design considerations for selecting the appropriate size of indent 96 in an indented cylinder type particle shape sorting apparatus 90 for use in the illustrated embodiment:

TABLE 1

aspect ratio

| | | | |
|---|---|---|---|
| 3 | 5 | 7 | 10 |

| | |
|---|---|
| dia, mm | particle length, mm |

| | | | | |
|---|---|---|---|---|
| 3.5 | 10.5 | 17.5 | 24.5 | 35.0 |
| 2.4 | 7.2 | 12.0 | 16.8 | 24.0 |
| 1.7 | 5.1 | 8.5 | 11.9 | 17.0 |
| 1.2 | 3.6 | 6.0 | 8.4 | 12.0 |
| 0.85 | 2.6 | 4.3 | 6.0 | 8.5 |
| 0.60 | 1.8 | 3.0 | 4.2 | 6.0 |
| 0.43 | 1.3 | 2.2 | 3.0 | 4.3 |
| 0.30 | 0.90 | 1.5 | 2.1 | 3.0 |
| 0.25 | 0.75 | 1.3 | 1.8 | 2.5 |

If the threshold aspect ratio for shape sorting is selected as 5:1, then ideally only particles having an aspect ratio of less than 5:1 will fit within the indents 96, thus enabling such particles to be lifted by the indents 96 and deposited in the trough 97. This result is not achievable in practice where a particle stream contains particles of varying sizes, since a 3:1 aspect ratio particle having a size of 0.43 mm has a length (about 1.3 mm) which is approximately equal to the length (about 1.3 mm) of a 5:1 aspect ratio particle having a size of 0.25 mm.

Referring to Table 1, for particle stream 82, which includes particles larger than 0.30 mm but smaller than 0.60 mm, the length of a 0.60 mm particle, a 0.30 mm particle and an intermediate 0.43 mm particle having an aspect ratio of 5:1 is about 3.0 mm, about 1.5 mm and about 2.2 mm respectively. Assuming that the intermediate 0.43 mm particle represents an average particle size within particle stream 82, then a nominal size of indent 96 of 2.2 mm could be selected as an initial sizing estimate and then adjusted as may be necessary to address the actual particle size distribution of particle stream 82 and other considerations pertaining to shape sorting step 6 efficiency and throughput.

In particular, the relative angle 98 of the trough 97, the size (i.e., diameter and/or depth) of the indents 96 and the residence time/throughput rate of the particles in the rotatable cylinder 94 may be adjusted to control the characteristics and yields of the relatively high aspect ratio constituent 8 and the relatively low aspect ratio constituent 10.

For example, it has been observed in testing that relatively lower aspect ratio particles will be collected in the indents 96 much more quickly than will relatively higher aspect ratio particles.

It has also been observed that as the average aspect ratio of the particles increases, relatively higher aspect ratio particles may be collected in the indents 96 more quickly because of the reduced numbers of relatively lower aspect ratio particles.

Finally, it has been observed that the optimal diameter of indent 96 is in most cases greater than the diameter suggested by the above determination of a nominal size of indent 96. The reason for this is believed to be related to the “dynamics” involved in delivering particles to the indents 96 as the rotatable cylinder 94 rotates. It has been observed during testing that “oversizing” the indents 96 generally increases the throughput rate of particles through the cylinder 94, probably due to an increase in the likelihood that a given particle will become collected in one of the indents 96 as the diameter of the indent 96 increases.

In addition to the above, and although grain sorting apparatus have been found to be generally effective for shape sorting particles of wollastonite ore 3, the operating conditions for a particular grain sorting apparatus may require adjustment in the practice of the invention due to the specific properties of the wollastonite ore 3.

As one example, wollastonite ore 3 tends to be somewhat more “elastic” than grain, with the result that the speed of rotation of the rotatable cylinder 94 may need to be adjusted downwards. In grain sorting applications, grain sorting apparatus may typically be operated at about 50 to 60 rpm, while in wollastonite ore sorting applications, the grain sorting apparatus may need to be operated at about 30 to 40 rpm or less.

As a second example, consideration may be required of expected wear rates of the grain sorting apparatus, and in particular the rotatable cylinder 94 during use in shape sorting wollastonite ore 3. Wollastonite ore 3, as an inorganic crystalline mineral, could be expected to be more abrasive and cause more wear than grain particles. This may require either that the rotatable cylinder 94 and other components of the grain sorting apparatus be modified to provide suitable wear resistance or that they be replaced frequently.

In the illustrated embodiment of the invention, similar or different configurations for the particle shape sorting apparatus 90 may be used for each of the particle streams 60, 62, 64, 72, 78, 80 and 82. Particle stream 75, which consists of particles smaller than about 0.25 mm, will not generally be subjected to the sorting step 6 in the grain sorting apparatus, but may be capable of being sorted in other particle shape sorting apparatus 90.

Particle shape sorting apparatus 90, particularly grain sorting apparatus, may be configured to handle feed streams in a series of stages (not shown) such that sorted material from a first rotatable cylinder 94 is fed to successive cylinders for further shape sorting before exiting from the equipment. Alternatively, particle shape sorting apparatus 90, particularly grain sorting apparatus, may be configured to handle feed streams in parallel (not shown) such that a feed stream is distributed to a plurality of rotatable cylinders 94. Such configurations may be used to increase the throughput in the shape sorting step 6 while facilitating relatively efficient sorting in the shape sorting step 6.

### EXAMPLES

The following Examples illustrate a number of points relating to the invention. As a first point, the Examples illustrate how the choice of size of indent 96 may affect the respective yields of the relatively high aspect ratio constituent and the relatively low aspect ratio constituent during shape sorting. As a second point, the Examples illustrate how the process of the present invention may be used to separate the relatively high aspect ratio constituent from impurities contained in the wollastonite ore.

In the following Examples, the term “LOI” refers to Loss-on-Ignition, which is the amount of weight loss in percent which is experienced by a particular wollastonite sample when it is heated to 1000 degrees Celsius.

Loss-on-Ignition is attributable to volatile impurities contained in a wollastonite ore and is a generally undesirable phenomenon, first since LOI experienced during high temperature commercial processes may affect surface finishes and may lead to shrinkage or warpage of manufactured parts and second, because many impurities found in wollastonite exhibit a relatively low aspect ratio and therefore compromise the performance of wollastonite in applications requiring high aspect ratio particles.

A particularly common impurity in wollastonite is calcium carbonate, a volatile mineral material which generally exhibits a very low aspect ratio.

Consequently, the amount of LOI exhibited by commercial wollastonite products is preferably minimized to avoid such detrimental effects. More particularly, the amount of LOI exhibited by commercial wollastonite products is preferably less than about 2.0 percent.

As a result, as a third point, the following Examples illustrate how the process of the invention may be used to reduce the impurities content of the relatively high aspect ratio constituent, although the yield of the high aspect ratio constituent generally decreases as the amount of LOI decreases.

### Example 1

In Example 1, wollastonite ore was obtained in the form of various hand samples from a mine located near Hermosillo Sonora, Mexico and operated by Minera Nyco S.A. de C.V.

The samples were size reduced first in a jaw type crusher 22 to particle sizes less than about 22 mm and were then size reduced in a high aspect ratio (HAR) type crusher 44 to particle sizes less than about 4.8 mm.

The size reduced particles were then screened and shape sorted into various fractions between about 4.750 mm and about −0.212 mm. The results of the testing for Example 1 are summarized in Table 2.

TABLE 2
ORE SAMPLE 1A INDENT TEST RESULTS

| | | | High | | | |
|---|---|---|---|---|---|---|
| | | | Aspect Ratio | | Low Aspect Ratio | |
| | | Indent | Constituent | | Constituent | |
| Fraction | Size | Size | Yield | LOI | Yield | LOI |
| (mm) | Ratio | (mm) | (%) | (%) | (%) | (%) |
| 4.750 × 3.350 | 1.42 | 23 | 64.4 | 0.98 | 35.6 | 1.96 |
| 3.350 × 1.700 | 1.97 | 18 | 70.3 | 0.90 | 29.7 | 2.53 |
| 1.700 × 1.180 | 1.44 | 12 | 82.2 | 0.67 | 17.8 | 3.72 |
| 1.180 × 0.850 | 1.39 | 8 | 67.7 | 0.53 | 32.3 | 4.5 |
| 0.850 × 0.600 | 1.42 | 4 | 35.2 | 0.83 | 64.8 | 5.93 |
| 0.600 × 0.300 | 2.00 | 4 | 72.8 | 0.61 | 27.2 | 3.43 |
| 0.300 × 0.212 | 1.42 | 4 | 92.6 | 0.68 | 7.4 | 2.19 |
| −0.212 | | | | | | |

The data in Table 2 illustrates how the process of the present invention can be used effectively to produce a relatively high aspect ratio constituent 10 which has a significantly lower LOI than a relatively low aspect ratio constituent 8 which is obtained from the same fraction.

### Example 2

In Example 2, wollastonite ore was obtained from a stockpile located at the Minera Nyco S.A. de C.V. mine located near Hermosillo Sonora, Mexico.

The samples had been size reduced in a jaw type crusher 22 to particle sizes less than about 150 mm. The samples had then been size reduced in a cone type crusher in two stages, first to particle sizes less than about 75 mm and then to particle sizes less than about 30 mm. The samples had then again been size reduced in a jaw type crusher 22 to particle sizes less than about 22 mm. Finally, the samples had been size reduced in a high aspect ratio (HAR) type crusher 44 to particle sizes less than about 9.5 mm.

The size reduced particles were then screened and shape sorted into various fractions between about 5.600 mm and about −0.212 mm. The results of the testing for Example 2 are summarized in Table 3.

TABLE 3
ORE SAMPLE 2A INDENT TEST RESULTS

| | | | High | | | |
|---|---|---|---|---|---|---|
| | | | Aspect Ratio | | Low Aspect Ratio | |
| | | Indent | Constituent | | Constituent | |
| Fraction | Size | Size | Yield | LOI | Yield | LOI |
| (mm) | Ratio | (mm) | (%) | (%) | (%) | (%) |
| 5.600 × 4.750 | 1.18 | 23 | 68.2 | 3.73 | 31.8 | 4.16 |
| 4.750 × 3.350 | 1.42 | 18 | 67.8 | 3.34 | 32.2 | 5.67 |
| 3.350 × 2.360 | 1.42 | 14 | 67.4 | 4.16 | 32.6 | 6.94 |
| 2.360 × 1.700 | 1.39 | 12 | 80.5 | 2.75 | 19.5 | 7.69 |
| 1.700 × 1.180 | 1.44 | 10 | 68.8 | 2.14 | 31.2 | 7.65 |
| 1.180 × 0.850 | 1.39 | 8 | 66.2 | 1.27 | 33.8 | 7.42 |
| 0.850 × 0.600 | 1.42 | 6 | 63.3 | 1.73 | 36.7 | 8.23 |
| 0.600 × 0.300 | 2.00 | 4 | 79.1 | 1.57 | 20.9 | 7.55 |
| 0.300 × 0.212 | 1.42 | 4 | 85.0 | 3.78 | 15.0 | 6.71 |
| −0.212 | | 4 | 77.6 | 6.37 | 22.4 | 6.25 |

The data in Table 3 illustrates that even at relatively high yields of the high aspect ratio constituent 10, the LOI of the relatively high aspect ratio constituent 10 is significantly lower than the LOI of the relatively low aspect ratio constituent 8 which is obtained from the same fraction.

The generally poor LOI characteristics exhibited by the samples from Example 2 may be attributed first, to poor quality of the wollastonite ore and second, to poor preparation of the wollastonite ore. The poor preparation of the wollastonite ore may be attributable to the ore having been crushed in a cone type crusher, which likely diminished the aspect ratio of the wollastonite ore.

### Example 3

In Example 3, wollastonite ore was obtained in the form of high aspect ratio (HAR) type crusher samples produced at the Minera Nyco S.A. de C.V. mine located near Hermosillo Sonora, Mexico.

The samples had been size reduced first in a jaw type crusher 22 to particle sizes less than about 22 mm and had then been size reduced in the high aspect ratio (HAR) type crusher 44 to particle sizes less than about 9.5 mm.

The size reduced particles were then screened and shape sorted into various fractions between about 5.600 mm and about −0.212 mm. The results of the testing for Example 3 are summarized in Table 4.

TABLE 4
ORE SAMPLE 2B INDENT TEST RESULTS

| | | | High | | | |
|---|---|---|---|---|---|---|
| | | | Aspect Ratio | | Low Aspect Ratio | |
| | | Indent | Constituent | | Constituent | |
| Fraction | Size | Size | Yield | LOI | Yield | LOI |
| (mm) | Ratio | (mm) | (%) | (%) | (%) | (%) |
| 5.600 × 4.750 | 1.18 | 23 | 39.3 | 0.50 | 60.7 | 0.58 |
| 4.750 × 3.350 | 1.42 | 18 | 42.1 | 0.52 | 57.9 | 1.24 |
| 3.350 × 2.360 | 1.42 | 14 | 46.7 | 0.56 | 53.3 | 1.93 |
| 2.360 × 1.700 | 1.39 | 12 | 49.6 | 0.56 | 50.4 | 2.54 |
| 1.700 × 1.180 | 1.44 | 10 | 44.5 | 0.34 | 55.5 | 2.39 |
| 1.180 × 0.850 | 1.39 | 8 | 50.1 | 0.30 | 49.9 | 2.58 |
| 0.850 × 0.600 | 1.42 | 6 | 52.3 | 0.38 | 47.7 | 2.24 |
| 0.600 × 0.300 | 2.00 | 4 | 56.8 | 0.53 | 43.2 | 1.89 |
| 0.300 × 0.212 | 1.42 | 4 | 72.4 | 0.68 | 27.6 | 1.43 |
| −0.212 | | 4 | 62.0 | 1.50 | 38.0 | 1.54 |

The data in Table 4 indicates a relatively high yield and a relatively low LOI for the relatively high aspect ratio constituent 10 for all fractions, thus further demonstrating the effectiveness of the shape sorting step of the process of the invention.

### Example 4

In Example 4, wollastonite ore was obtained from a stockpile located at the Minera Nyco S.A. de C.V. mine located near Hermosillo Sonora, Mexico.

The samples were size reduced first in a jaw type crusher 22 to particle sizes less than about 62 mm and were then size reduced in a high aspect ratio (HAR) type crusher 44 to particle sizes less than about 3.5 mm.

The size reduced particles were then screened and shape sorted into various fractions between about 3.53 mm and about −0.23 mm. The results of the testing for Example 4 are summarized in Table 5.

For each of the test runs summarized in Table 5, the sorting step 6 was carried out until a desired yield of the relatively high aspect ratio constituent 10 was achieved, with the result that the residence time of the particles of wollastonite ore 3 in the particle shape sorting apparatus 90 varied throughout the test runs. In the test runs summarized in Table 5, the yield of the relatively high aspect ratio constituent 10 generally decreased as the residence time of the particles of wollastonite ore 3 in the particle shape sorting apparatus 90 was increased.

TABLE 5
ORE SAMPLE 3 INDENT TEST RESULTS

| | | | High | | | |
|---|---|---|---|---|---|---|
| | | | Aspect Ratio | | Low Aspect Ratio | |
| | | Indent | Constituent | | Constituent | |
| Fraction | Size | Size | Yield | LOI | Yield | LOI |
| (mm) | Ratio | (mm) | (%) | (%) | (%) | (%) |
| 3.53 × 2.29 | 1.54 | 18 | 21.7 | 0.94 | 78.3 | 2.42 |
| 3.53 × 2.29 | 1.54 | 14 | 38.7 | 1.16 | 61.3 | 3.12 |
| 3.53 × 2.29 | 1.54 | 16 | 40.6 | 1.23 | 59.4 | 2.63 |
| 3.53 × 2.29 | 1.54 | 14 | 45.4 | 1.25 | 54.6 | 2.98 |
| 3.53 × 2.29 | 1.54 | 16 | 46.2 | 1.33 | 53.8 | 3.00 |
| 3.53 × 2.29 | 1.54 | 12 | 73.2 | 1.39 | 26.8 | 3.76 |
| 3.53 × 2.29 | 1.54 | 12 | 77.5 | 1.69 | 22.5 | 3.79 |
| 2.29 × 1.65 | 1.39 | 16 | 14.5 | 0.55 | 85.5 | 2.56 |
| 2.29 × 1.65 | 1.39 | 16 | 20.7 | 0.72 | 79.3 | 2.53 |
| 2.29 × 1.65 | 1.39 | 12 | 49.1 | 1.06 | 50.9 | 3.49 |
| 2.29 × 1.65 | 1.39 | 12 | 39.4 | 1.03 | 60.6 | 3.50 |
| 2.29 × 1.65 | 1.39 | 14 | 38.3 | 1.12 | 61.7 | 3.09 |
| 2.29 × 1.65 | 1.39 | 10 | 68.6 | 1.16 | 31.4 | 4.79 |
| 2.29 × 1.65 | 1.39 | 10 | 70.5 | 1.16 | 29.5 | 4.45 |
| 2.29 × 1.65 | 1.39 | 10 | 71.0 | 1.37 | 29.0 | 5.19 |
| 2.29 × 1.65 | 1.39 | 10 | 73.8 | 1.57 | 26.2 | 5.41 |
| 1.65 × 1.18 | 1.40 | 12 | 17.7 | 0.52 | 82.3 | 3.31 |
| 1.65 × 1.18 | 1.40 | 12 | 21.9 | 0.73 | 78.1 | 3.63 |
| 1.65 × 1.18 | 1.40 | 10 | 35.0 | 0.59 | 65.0 | 3.20 |
| 1.65 × 1.18 | 1.40 | 10 | 43.9 | 0.65 | 56.1 | 4.52 |
| 1.65 × 1.18 | 1.40 | 8 | 72.3 | 1.31 | 27.7 | 6.19 |
| 1.65 × 1.18 | 1.40 | 8 | 74.4 | 1.10 | 25.6 | 6.58 |
| 1.18 × 0.86 | 1.37 | 10 | 16.1 | 0.55 | 83.9 | 4.26 |
| 1.18 × 0.86 | 1.37 | 10 | 13.9 | 0.50 | 86.1 | 4.11 |
| 1.18 × 0.86 | 1.37 | 8 | 36.7 | 0.72 | 63.3 | 5.06 |
| 1.18 × 0.86 | 1.37 | 8 | 43.2 | 1.00 | 56.8 | 5.68 |
| 1.18 × 0.86 | 1.37 | 6 | 69.5 | 1.95 | 30.5 | 6.76 |
| 1.18 × 0.86 | 1.37 | 6 | 84.3 | 2.42 | 15.7 | 6.64 |
| 0.86 × 0.54 | 1.59 | 8 | 19.8 | 0.54 | 80.2 | 4.97 |
| 0.86 × 0.54 | 1.59 | 8 | 21.1 | 0.60 | 78.9 | 4.88 |
| 0.86 × 0.54 | 1.59 | 6 | 47.3 | 1.31 | 52.7 | 6.16 |
| 0.86 × 0.54 | 1.59 | 6 | 49.8 | 1.31 | 50.2 | 5.47 |
| 0.86 × 0.54 | 1.59 | 4 | 59.3 | 1.16 | 40.7 | 9.25 |
| 0.86 × 0.54 | 1.59 | 4 | 64.4 | 0.87 | 35.6 | 8.07 |
| 0.54 × 0.42 | 1.29 | 6 | 15.4 | 0.88 | 84.6 | 4.00 |
| 0.54 × 0.42 | 1.29 | 6 | 16.6 | 0.87 | 83.4 | 4.10 |
| 0.54 × 0.42 | 1.29 | 4 | 27.3 | 0.70 | 72.7 | 5.12 |
| 0.54 × 0.42 | 1.29 | 4 | 31.0 | 0.53 | 69.0 | 5.36 |
| 0.42 × 0.31 | 1.4 | 4 | 6.0 | 0.68 | 94.0 | 4.62 |
| 0.42 × 0.31 | 1.4 | 4 | 10.4 | 0.62 | 89.6 | 4.56 |
| 0.42 × 0.31 | 1.4 | 4 | 24.0 | 1.72 | 76.0 | 5.27 |
| 0.42 × 0.31 | 1.4 | 4 | 28.8 | 1.51 | 71.2 | 4.68 |
| 0.42 × 0.31 | 1.4 | 4 | 42.2 | 2.45 | 57.8 | 4.95 |
| 0.42 × 0.31 | 1.4 | 4 | 45.6 | 2.38 | 54.4 | 5.50 |
| 0.31 × 0.23 | 1.35 | 4 | 8.0 | 0.80 | 92.0 | 3.30 |
| 0.31 × 0.23 | 1.35 | 4 | 12.6 | 0.86 | 87.4 | 3.26 |
| 0.31 × 0.23 | 1.35 | 4 | 21.6 | 1.00 | 78.4 | 3.50 |
| 0.31 × 0.23 | 1.35 | 4 | 38.9 | 1.91 | 61.1 | 3.88 |
| 0.31 × 0.23 | 1.35 | 4 | 46.2 | 2.28 | 53.8 | 4.31 |
| 0.31 × 0.23 | 1.35 | 4 | 51.2 | 1.84 | 48.8 | 3.62 |

The data in Table 5 indicates a general trend that the LOI of the relatively high aspect ratio constituent 10 may generally increase as the yield of the relatively high aspect ratio constituent 10 increases. In other words, the effectiveness of the separation of the constituents 8,10 may tend to decrease as the yield of the relatively high aspect ratio constituent 10 increases.

After the shape sorting step 6, grinding or other processing of the relatively low aspect ratio constituents 10 from the various particle streams may be performed to create a uniform wollastonite product. Grinding or other processing of the relatively high aspect ratio constituents 8 to produce one or more wollastonite products having a reduced, uniform particle size is also possible using grinding or other techniques and apparatus.

As previously stated, effective performance of the process of the invention is subject to a maximum particle size which is dependent upon the wollastonite ore deposit, and is a function of the maximum particle size at which wollastonite particles become liberated from the wollastonite ore deposit and thus exhibit acicularity.

It has similarly been found during testing that there is a minimum particle size which can be effectively subjected to the sorting step 6. This minimum particle size is also dependent upon the wollastonite ore 3 deposit, and is a function of handling difficulties in the sorting apparatus 90 as well as inherent difficulties in performing shape sorting of fine particles. It is generally more difficult to distinguish aspect ratios amongst fine particles in the sorting apparatus 90, and this is particularly the case where the sorting apparatus 90 is in indented cylinder type shape sorting apparatus.

With the wollastonite ore 3 deposit used in testing, it has been determined that particles smaller than about 0.25 mm are difficult to sort in the grain sorting apparatus. In addition, the achievable throughput of material through the grain sorting apparatus tends to diminish significantly at particle sizes less than about 0.25 mm. Shape sorting of particles smaller than about 0.25 mm may however be possible using other types of particle shape sorting apparatus 90.

The throughput, efficiency and overall effectiveness of the grain sorting apparatus is also dependent on providing a “tight sizing”, “closely sized feed” or “closely sized screen fraction” to the apparatus 90. In other words, the range of particle sizes of wollastonite material that is delivered for processing in the grain sorting apparatus is preferably quite narrow such that the difference between an upper limit particle size and a lower limit particle size is preferably minimized.

This result is achieved in the practice of the invention by the creation of the particle streams 60, 62, 64, 72, 78, 80 and 82. The number of particle streams that are created and the particle size ranges of the various particle streams is dependent upon the wollastonite ore 3 deposit, the sorting apparatus, and the threshold aspect ratio at which the sorting step 6 is carried out. The goal in providing a “tight sizing” or “closely sized feed” is to facilitate operation of the apparatus 90 such that to the extent practical, the apparatus 90 need only distinguish particle shape and not particle size.

In the illustrated embodiment and in the Examples, the size ratio of an upper limit particle size to a lower limit particle size for a particular particle stream is preferably less than about 2. More preferably this size ratio is between about 1.2 and about 2 (see Examples 2 and 3), is even more preferably between about 1.3 and about 2 (see Example 1), and is most preferably between about 1.2 and about 1.6 or between about 1.3 and about 1.6 (see Example 4).

It will be appreciated that each particle stream created in separating step 4 may include particles that are outside the particle size range of the particle stream due to inherent inefficiencies in the separating step 4 and/or the mesh screening apparatus. The amount of misplaced material (i.e. material outside the desired particle size range) in a particle stream should be minimized and should preferably be less than about 20% by weight of the particle stream and more preferably less than about 10% by weight of the particle stream.

While the use of an grain sorting apparatus, and in particular an indented cylinder type grain sorting apparatus, has been described in detail as a preferred particle shape sorting apparatus 90, it will be understand by a person skilled in the art that the particle streams produced by separating step 4 may be shape sorted using other techniques and equipment. Shape sorting techniques and equipment typically take advantage or one or some combination of the following dynamic behaviors that depend on shape:

1. velocities across an inclined surface;

2. time required to pass through a screen surface;

3. adhesion to a solid surface; or

4. settling velocity in a liquid.

As is the case specifically with grain sorting apparatus, shape sorting techniques and apparatus generally rely upon a “tight sizing” or “closely sized feed” in order to be effective and upon relatively low throughput in order to attain high sorting efficiencies. The minimum particle size of particles which can be effectively shape sorted using shape sorting techniques and equipment is generally about 0.05 mm, due to the tendency of finer particles to agglomerate.

With techniques and equipment that rely on particle velocities across inclined surfaces, particles tend to be sorted according to how much of their surface area is in contact with the inclined surface. Particles with shapes close to a sphere have a small frictional component and thereby readily roll down the inclined surface. Non-spherical particles, such as acicular wollastonite particles, have a larger frictional component and move at a correspondingly lower rate down the inclined surface. Equipment that relies on particle velocities for shape sorting includes:
1. inclined plates (simplest but least efficient);
2. inclined conveyors (relatively large processing rate);
3. inclined troughs (relatively large separation range);
4. inclined rotating discs (relatively low throughput);
5. inclined rotating cones (a higher separation efficiency than the disc);
6. inclined rotating cylinders (a very high separation efficiency when flighted).
7. spiral flight gravity separators (no moving parts and thus low energy requirements)

Vibration or rotation tends to increase the sorting efficiency by reducing the tendency for spherical particles to be obstructed by non-spherical particles.

With equipment and methods that rely on time required to pass through a sieve, the basic principle of sorting is that longer particles (wollastonite) take longer to achieve an orientation which allows passage through the screen aperture. The passage rate, however, is also affected by sieve operating conditions such as feed rate, angle of inclination, vibrational characteristics, and the number of screen decks. Equipment that relies on sieve methods includes:
1. vibrating stacked screens with the same aperture (known as sieve-cascadographs);
2. inclined vibrating screens in which higher aspect ratio particles tend to travel further down the screen deck;
3. inclined rotating cylindrical sieves;
4. indented cylinder separators (grain sorting apparatus typically are included in this category).

Equipment that relies on adhesion to shape sort particles typically comprises a drum with circular holes. Particles are held onto the surface of the drum by suction. Spherical particles tend to be held more tightly than non-spherical particles, and the non-spherical particles can be brushed off into a separate collector. Spherical particles are releasable with compressed air. The surface roughness of the particles, humidity, and temperature all affect performance. Shape sorting of particles having a particle size of less than about 0.1 mm may be possible using this equipment.

Equipment and methods that rely on settling velocities take advantage of the fact that particles settling in a fluid experience drag forces. A particle will settle in a fluid according to its drag coefficient which depends on Reynolds number and also on particle shape. The terminal velocity for an elongated particle such as a wollastonite particle is less than the terminal velocity of a sphere of the same volume. If particles are closely sized, there is a correlation between settling rate and aspect ratio. In principle, very small particles can be sorted using this technique.

Generally, settling velocity equipment comprises long troughs with near laminar flow. The particles to be sorted are introduced at one end and collection hoppers along the length of the trough collect the particles according to shape. The fluid is generally water, but air may also be used. As a variation on this technique, hydroclones or hydrocyclones may be effective for shape sorting and have the advantage of potentially achieving relatively high throughputs.

Although the present invention has been described in some detail by way of example for purposes of clarity and understanding, it will be apparent that certain changes and modifications may be practised within the scope of the appended claims.

In particular, it will be apparent that the process of the invention may be utilized for shape sorting natural or man-made aspect ratio materials other than wollastonite, with the only limitation being that the material to be shape sorted must be provided as an aspect ratio material.

We claim:

1. A process for shape sorting an aspect ratio material, the process comprising:
providing particles of the aspect ratio material having a size less than a preselected maximum size;
separating the particles of the aspect ratio material into a plurality of particle streams based on particle size, each particle stream being formed substantially from particles of the aspect ratio material having a size within a range of particle sizes; and
sorting the particles of the aspect ratio material in at least one of the plurality of particle streams based on particle shape into a relatively high aspect ratio constituent and a relatively low aspect ratio constituent.

2. A process as claimed in claim 1 in which the aspect ratio material is comprised of wollastonite ore.

3. A process as claimed in claim 2 in which the preselected maximum size of the particles of the aspect ratio material is about 3.5 mm.

4. A process as claimed in claim 2 further comprising a step of size reducing the wollastonite ore into the particles of the aspect ratio material having the size less than the preselected maximum size.

5. A process as claimed in claim 4 in which the size reducing step comprises:
delivering the wollastonite ore into a size reducing apparatus;
separating particles from the size reducing apparatus into particles having a size greater than the preselected maximum size and particles having a size less than the preselected maximum size;
feeding particles greater than the preselected maximum size back into the size reducing apparatus; and
delivering the particles of the aspect ratio material having the size less than the preselected maximum size for separating.

6. A process as claimed in claim 4 in which the size reducing step is comprised of at least two stages, with particles being size reduced to an intermediate size at a first stage and delivered to at least one subsequent stage for further size reducing until the wollastonite ore is size reduced sufficiently to produce the particles of the aspect ratio material having the size less than the preselected maximum size.

7. A process as claimed in claim 2 in which the separating step comprises delivering the particles of the aspect ratio material to a particle size separating apparatus and separating the particles of the aspect ratio material into the plurality of particle streams with the particle size separating apparatus.

8. A process as claimed in claim 7 in which the particle size separating apparatus comprises at least one mesh screen having a mesh screen size and wherein the separating step is comprised of screening the particles of the aspect ratio material with the mesh screen.

9. A process as claimed in claim 8 in which screening the particles of the aspect ratio material with the mesh screen creates one particle stream in which the particles of the aspect ratio material have a size greater than the mesh screen size and another particle stream in which the particles of the aspect ratio material have a size less than the mesh screen size.

10. A process as claimed in claim 7 in which the particle size separating apparatus comprises a plurality of mesh screens having different mesh screen sizes and wherein the separating step is comprised of selectively screening the particles of the aspect ratio material with the plurality of mesh screens to create the plurality of particle streams.

11. A process as claimed in claim 2 in which each particle stream created in the separating step includes particles of the aspect ratio material which have a size which is outside of the range of particle sizes of the particle stream in an amount less than about 20% by weight of the particle stream.

12. A process as claimed in claim 2 in which each particle stream created in the separating step includes particles of the aspect ratio material which have a size which is outside of the range of particle sizes of the particle stream in an amount less than about 10% by weight of the particle stream.

13. A process as claimed in claim 2 in which the sorting step comprises delivering the particle stream to be sorted to a particle shape sorting apparatus and sorting the particles of the aspect ratio material in the particle stream with the particle shape sorting apparatus.

14. A process as claimed in claim 13 in which the particle shape sorting apparatus comprises grain sorting apparatus.

15. A process as claimed in claim 2 in which a plurality of the particle streams is to be sorted, in which the plurality of the particle streams to be sorted is delivered to a plurality of particle shape sorting apparatus, and in which the plurality of the particle streams to be sorted is sorted in the plurality of particle shape sorting apparatus to produce a plurality of relatively high aspect ratio constituents and a plurality of relatively low aspect ratio constituents.

16. A process as claimed in claim 2 including cleaning of the relatively low aspect ratio constituent to remove gangue.

17. A process as claimed in claim 16 including grinding of the relatively low aspect ratio constituent after cleaning.

18. A process as claimed in claim 2 including grinding of the relatively high aspect ratio constituent to produce a product having a reduced particle size.

19. A relatively high aspect ratio constituent of wollastonite ore produced according to the process of claim 2.

20. A system for shape sorting an aspect ratio material, the system comprising:
particle size separating apparatus to separate particles of the aspect ratio material having a size less than a preselected maximum size into a plurality of particle streams based on particle size, each particle stream being formed substantially from particles of the aspect ratio material having a size within a range of particle sizes; and
particle shape sorting apparatus associated with at least one of the plurality of particle streams to sort the particles of the aspect ratio material in the particle stream based on particle shape into a relatively high aspect ratio constituent and a relatively low aspect constituent.

21. A process as claimed in claim 20 in which the aspect ratio material is comprised of wollastonite ore.

22. A system as claimed in claim 21 in which the particle size separating apparatus comprises at least one mesh screen.

23. A system as claimed in claim 21 in which the particle shape sorting apparatus comprises grain sorting apparatus.

24. A system as claimed in claim 21 in which a plurality of particle shape sorting apparatus is associated with a plurality of the particle streams for sorting the plurality of particle streams based on particle shape to produce a plurality of relatively high aspect ratio constituents and a plurality of relatively low aspect ratio constituents.

25. A system as claimed in claim 21 further comprising a size reducing apparatus to size reduce the wollastonite ore into the particles of the aspect ratio material having the size less than the preselected maximum size.

26. A system as claimed in claim 25 in which the size reducing apparatus is selected so that it will not significantly diminish the aspect ratio of the aspect ratio material.

27. A constituent of wollastonite ore comprising the following properties:
at least 80% by weight of the constituent of wollastonite ore having a particle size within a range of particle sizes, wherein the range of particle sizes is defined by an upper limit particle size and a lower limit particle size, and wherein the ratio of the upper limit particle size to the lower limit particle size is less than about 2; and
a Loss-on-Ignition value of less than about 2%.

28. A constituent of wollastonite ore as claimed in claim 27 in which the ratio of the upper limit particle size to the lower limit particle size is between about 1.2 and 2.

29. A constituent of wollastonite ore as claimed in claim 27 in which the ratio of the upper limit particle size to the lower limit particle size is between about 1.2 and 1.6.

30. A constituent of wollastonite ore as claimed in claim 27 in which at least 90% by weight of the constituent of wollastonite ore has a particle size within the range of particle sizes.

31. A constituent of wollastonite ore as claimed in claim 30 in which the ratio of the upper limit particle size to the lower limit particle size is between about 1.2 and 1.6.
